(19) United States
(12) Patent Application Publication
(10) Pub. No.: US 2026/0264708 A1
(43) Pub. Date: Sep. 10, 2026

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Takahiro Shimizu, Tokyo (JP); Sho Tamura, Tokyo (JP)

(21) Appl. No.: 19/550,465

(22) Filed: Feb. 26, 2026

(30) Foreign Application Priority Data
Mar. 7, 2025 (JP) 2025-036532

(51) Int. Cl. B60W 50/08; B60W 10/20; B60W 30/12

(52) U.S. Cl. CPC B60W 50/082; B60W 10/20; B60W 30/12; B60W 2552/53; B60W 2554/80; B60W 2556/40; B60W 2710/20

(57) ABSTRACT

A vehicle control device of an embodiment includes a processor that executes instructions to: recognize a first dividing line, a second dividing line, and an object around a vehicle; perform first comparison processing based on the first dividing line and the second dividing line; and perform driving control of the vehicle, wherein second comparison processing based on the object is performed if a degree of discrepancy between the first dividing line and the second dividing line is at least a threshold value in the first comparison processing, the driving control is continued if the first driving mode is being executed and at least one of the degree of discrepancy between the object and the first dividing line and the degree of discrepancy between the object and the second dividing line based on the results of the second comparison processing is less than the threshold value.

### CROSS-REFERENCE TO RELATED APPLICATION

Priority is claimed on Japanese Patent Application No. 2025-036532, filed Mar. 7, 2025, the content of which is incorporated herein by reference.

### BACKGROUND

### Field of the Invention

The present invention relates to a vehicle control device, a vehicle control method, and a storage medium.

### Description of the Related Art

In recent times, efforts to provide access to sustainable transportation systems that take into consideration vulnerable people among traffic participants have become more active. To achieve this, the focus is on research and development to further improve traffic safety and convenience through research and development into automated driving technology. In this regard, in recent years, in recognizing surroundings of a vehicle, a technology of increasing reliability when a road sign recognized from an image matches a road sign in map information stored in a storage, and if the reliability is at least a predetermined value, determining that the road sign stored in the storage is the road sign corresponding to a current location has become known (for example, Japanese Unexamined Patent Application, First Publication No. 2019-212188).

### SUMMARY

Incidentally, in the automated driving technology in the related art, when dividing lines recognized on the basis of an output of a detection device such as an imager are discrepant from dividing lines recognized from the map information, which dividing lines are to be used for driving control may vary depending on surrounding conditions. For that reason, there is a problem that, depending on the surrounding conditions, it may be impossible to properly recognize the dividing lines, and appropriate driving control may not be executed.

In order to solve the above problems, one of objects of the present application is to provide a vehicle control device, a vehicle control method, and a storage medium in which more appropriate driving control can be executed by improving recognition accuracy of dividing lines. In addition, this ultimately contributes to the development of sustainable transportation systems.

A vehicle control device, a vehicle control method, and a storage medium according to the present invention employ the following configurations.

(1): A vehicle control device according to one aspect of the present invention is a vehicle control device including: a first recognizer configured to recognize dividing lines defining a travel lane of a vehicle as a first dividing line on the basis of an output of a first detection device detecting dividing lines around the vehicle; a second recognizer configured to recognize dividing lines defining the travel lane of the vehicle from map information as a second dividing line on the basis of position information of the vehicle; a third recognizer configured to recognize an object around the vehicle on the basis of an output of a second detection device detecting surrounding conditions of the vehicle; a comparer configured to perform first comparison processing based on the first dividing line and the second dividing line; and a driving controller configured to perform driving control of the vehicle on the basis of the results of the first comparison processing, wherein the comparer performs second comparison processing including at least one of comparison of the object recognized by the third recognizer with the first dividing line and comparison of the object with the second dividing line if a degree of discrepancy between the first dividing line and the second dividing line is at least a threshold value in the first comparison processing, the driving control includes at least a first driving mode and a second driving mode in which a degree of driving assistance is lower than in the first driving mode or tasks on the occupant of the vehicle are greater than in the first driving mode, and the driving controller continues the first driving mode if the first driving mode is being executed and at least one of the degree of discrepancy between the object and the first dividing line and the degree of discrepancy between the object and the second dividing line based on the results of the second comparison processing is less than the threshold value.

(2): In the above aspect (1), the processor performs comparison one prioritized dividing line between the first dividing line and the second dividing line and the object, as the second comparison processing, and the processor continues the first driving mode if the first driving mode is being executed and the degree of discrepancy between the one prioritized dividing line and the object is less than the threshold value on the basis of the results of the second comparison processing.

(3): In the above aspect (1), the processor performs comparison the object and the first dividing line and comparison the object and the second dividing line as the second comparison processing, and the processor continues the first driving mode if the first driving mode is being executed and at least one of the degree of discrepancy between the object and the first dividing line and the degree of discrepancy between the object and the second dividing line based on the results of the second comparison processing is less than the threshold value.

(4): In the above aspect (1), the processor switches from the first driving mode to the second driving mode if the first driving mode is being executed and the degree of discrepancy from the object based on the second comparison processing is at least the threshold value.

(5): In the above aspect (1), the processor performs at least steering control of the vehicle on the basis of the dividing line having the smaller degree of discrepancy between the first dividing line and the second dividing line if the degree of discrepancy from a position of the object based on the second comparison processing is less than the threshold value.

(6): In the above aspect (2), the processor performs at least steering control of the vehicle on the basis of one prioritized dividing line if the degree of discrepancy between a position of the object and the one prioritized dividing line based on the second comparison processing is less than the threshold value.

(7): In the above aspect (1), the processor derives the degree of discrepancy between the dividing line serving as a comparison target and the object on the basis of a degree of parallelism between the dividing line serving as the comparison target among the first and second dividing lines and one or more of the objects recognized in the second comparison processing.

(8): A vehicle control method according to one aspect of the present invention is a vehicle control method configured to cause a computer to execute: recognizing dividing lines defining a travel lane of a vehicle as a first dividing line on the basis of an output of a first detection device detecting dividing lines around the vehicle; recognizing dividing lines defining the travel lane of the vehicle from map information as a second dividing line on the basis of position information of the vehicle; recognizing an object around the vehicle on the basis of an output of a second detection device detecting surrounding conditions of the vehicle; performing first comparison processing based on the first dividing line and the second dividing line; performing driving control of the vehicle on the basis of the results of the first comparison processing; and performing second comparison processing including at least one of comparison of the object with the first dividing line and comparison of the object with the second dividing line if a degree of discrepancy between the first dividing line and the second dividing line is at least a threshold value in the first comparison processing, wherein the driving control includes at least a first driving mode and a second driving mode in which a degree of driving assistance is lower than in the first driving mode or tasks on the occupant of the vehicle are greater than in the first driving mode, and the first driving mode is continued if the first driving mode is being executed and at least one of the degree of discrepancy between the object and the first dividing line and the degree of discrepancy between the object and the second dividing line based on the results of the second comparison processing is less than the threshold value.

(9): A storage medium according to one aspect of the present invention is a computer-readable non-transitory storage medium storing a program configured to cause a computer to execute: recognizing dividing lines defining a travel lane of a vehicle as a first dividing line on the basis of an output of a first detection device detecting dividing lines around the vehicle; recognizing dividing lines defining the travel lane of the vehicle from map information as a second dividing line on the basis of position information of the vehicle; recognizing an object around the vehicle on the basis of an output of a second detection device detecting surrounding conditions of the vehicle; performing first comparison processing based on the first dividing line and the second dividing line; performing driving control of the vehicle on the basis of the results of the first comparison processing; and performing second comparison processing including at least one of comparison of the object with the first dividing line and comparison of the object with the second dividing line if a degree of discrepancy between the first dividing line and the second dividing line is at least a threshold value in the first comparison processing, wherein the driving control includes at least a first driving mode and a second driving mode in which a degree of driving assistance is lower than in the first driving mode or tasks on the occupant of the vehicle are greater than in the first driving mode, and the first driving mode is continued if the first driving mode is being executed and at least one of the degree of discrepancy between the object and the first dividing line and the degree of discrepancy between the object and the second dividing line based on the results of the second comparison processing is less than the threshold value.

According to the above aspects (1) to (9), by improving the recognition accuracy of dividing lines, more appropriate driving control can be executed.

### DESCRIPTION OF EMBODIMENTS

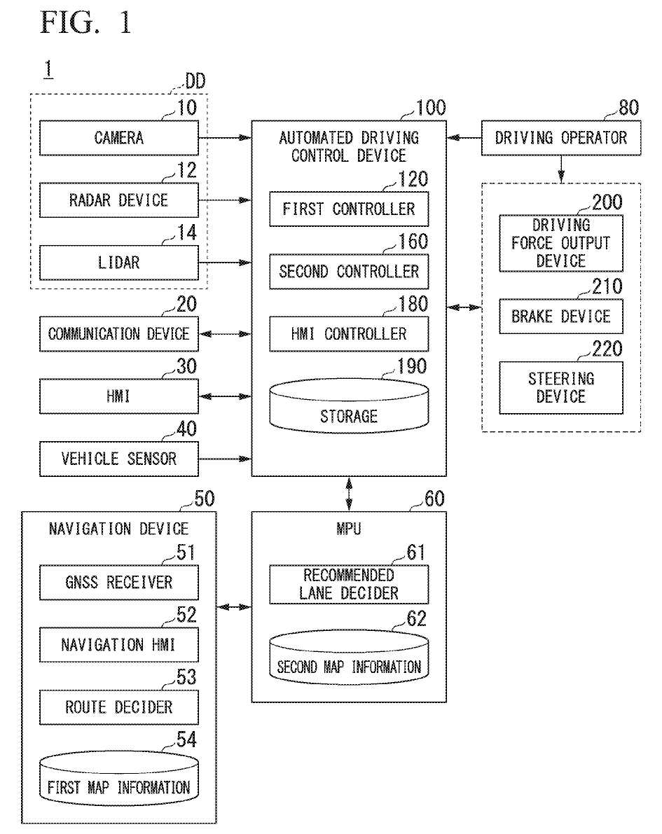

FIG. 1 is a configuration diagram of a vehicle system including a vehicle control device according to an embodiment.

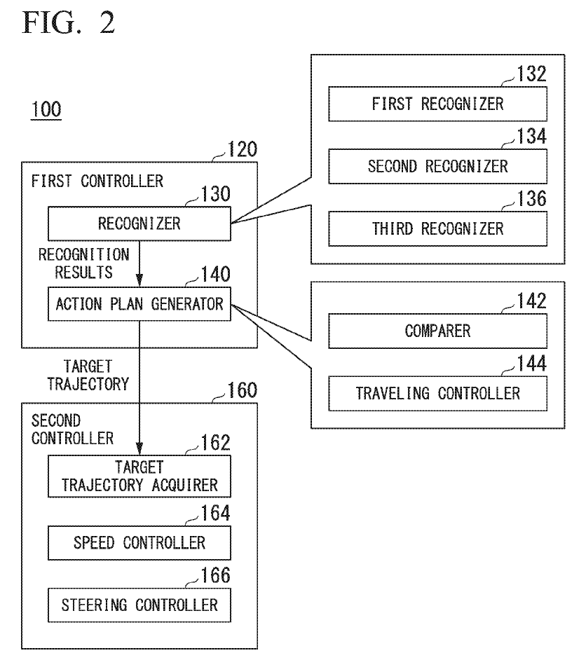

FIG. 2 is a functional configuration diagram of a first controller and a second controller.

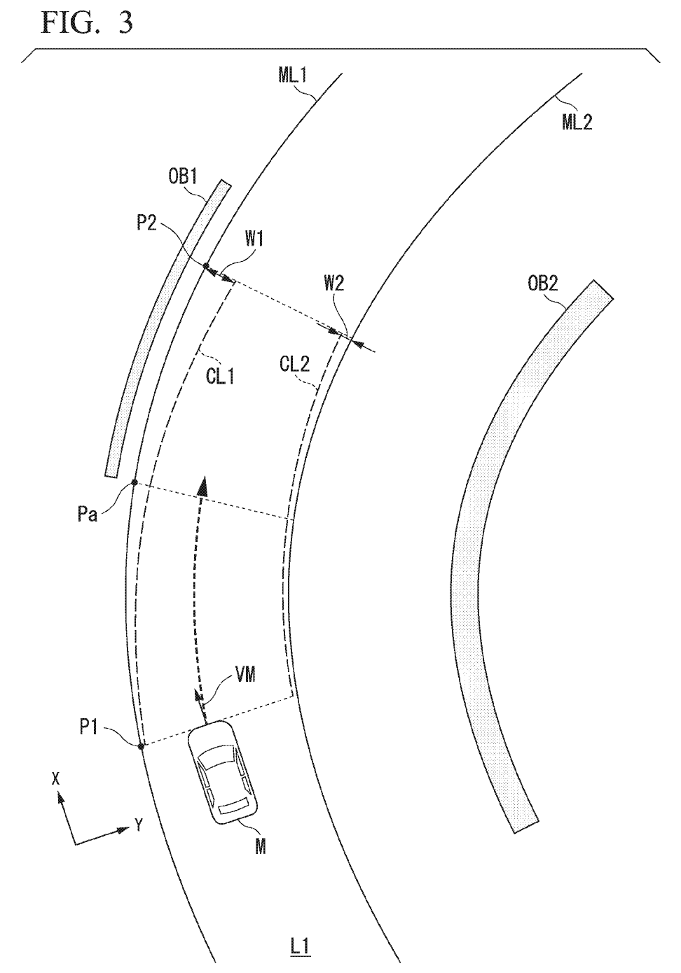

FIG. 3 is a diagram showing an example of a traveling condition of a vehicle according to an embodiment.

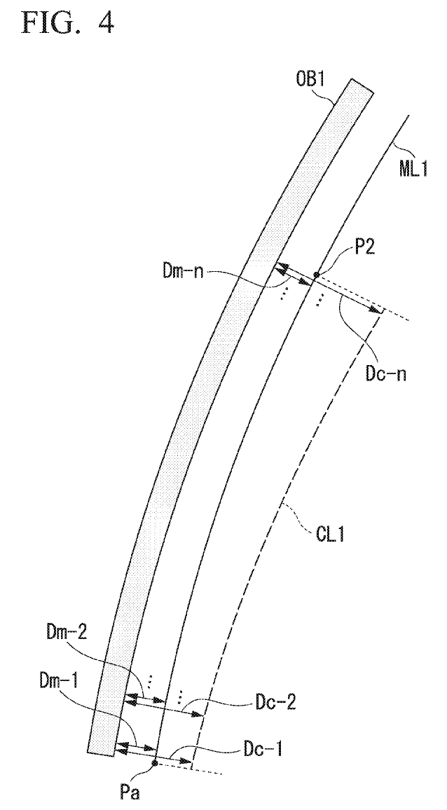

FIG. 4 is a diagram for describing a method for deriving a degree of parallelism.

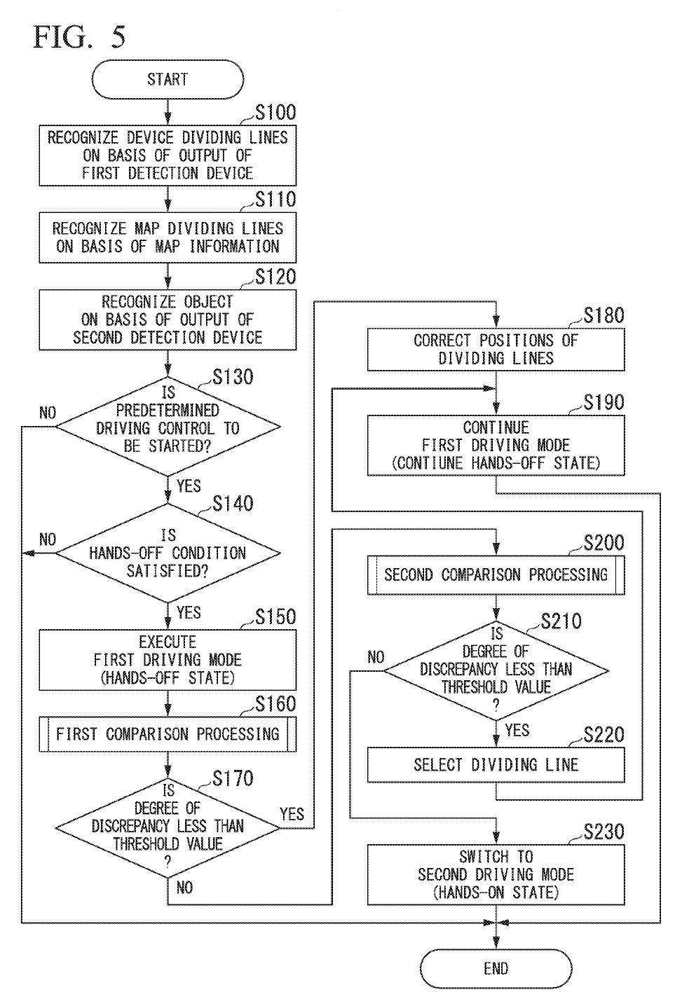

FIG. 5 is a flowchart showing an example of a flow of a driving control process according to an embodiment.

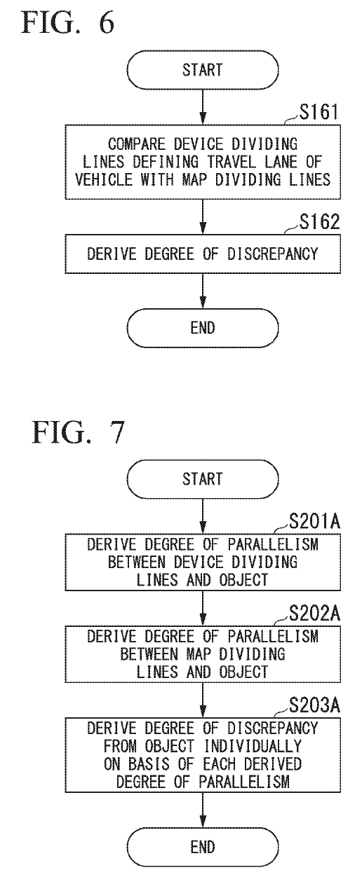

FIG. 6 is a flowchart showing an example of first comparison processing.

FIG. 7 is a flowchart showing a first example of second comparison processing.

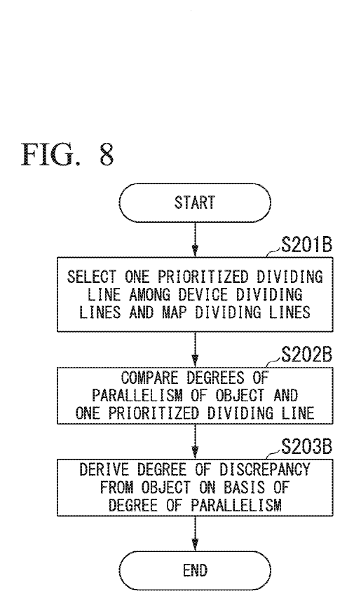

FIG. 8 is a flowchart showing a second example of the second comparison processing.

### DESCRIPTION OF EMBODIMENTS

Embodiments of a vehicle control device, a vehicle control method, and a storage medium of the present invention will be described below with reference to the drawings. In the following description, an embodiment in which the vehicle control device is applied to an automated driving vehicle will be described. Autonomous driving indicates, for example, automatically controlling one or both of steering and a speed of a vehicle to perform driving control. Examples of the above-described driving control may include various types of driving control, for example, an adaptive cruise control system (ACC), a lane keeping assistance system (LKAS), automated lane change (ALC), traffic jam pilot (TJP), collision mitigation brake system (CMBS), and the like. Also, for an automated driving vehicle, driving control may be performed by a manual operation of a user (for example, an occupant) of a vehicle (so-called manual driving). Further, the vehicle control device according to the embodiment may be applied, in addition to vehicles, for example, to mobile objects such as ships that can move on the ground like hovercrafts, aircraft that can travel on roads, and stand-up vehicles having a power unit.

### Overall Configuration

FIG. 1 is a configuration diagram of a vehicle system 1 including the vehicle control device according to the present embodiment. A vehicle (hereinafter referred to as a vehicle M) in which the vehicle system 1 is mounted is, for example, a vehicle such as a two-wheeled, three-wheeled, or four-wheeled vehicle or micromobility, and a drive source thereof is an internal combustion engine such as a diesel engine or a gasoline engine, an electric motor, or a combination of these. An electric motor operates using electric power generated by a generator connected to an internal combustion engine or discharged power from a battery (storage battery) such as a secondary battery or a fuel cell.

The vehicle system 1 includes, for example, a camera 10, a radar device 12, a light detection and ranging (LIDAR) 14, a communication device 20, a human machine interface (HMI) 30, a vehicle sensor 40, a navigation device 50, a map positioning unit (MPU) 60, a driving operator 80, an automated driving control device 100, a driving force output device 200, a brake device 210, and a steering device 220. These devices and apparatuses are connected to each other via multiple communication lines such as a controller area network (CAN) communication line, serial communication lines, wireless communication networks, or the like. Further, the configuration shown in FIG. 1 is merely an example, and some of the configuration may be omitted, or other configurations may be further added. A combination of the camera 10, the radar device 12, the LIDAR 14, and the like is an example of a “detection device DD.” In addition, the camera 10 is an example of a “first detection device,” and the radar device 12 is an example of a “second detection device.” Also, the second detection device may include the LIDAR 14. The HMI 30 is an example of an “output device.” The automated driving control device 100 is an example of a “vehicle control device.”

The camera 10 is, for example, a digital camera using a solid-state image sensor such as a charge coupled device (CCD) or a complementary metal oxide semiconductor (CMOS). The camera 10 is attached to any location on the vehicle M in which the vehicle system 1 is mounted. In the case of imaging the front, the camera 10 is attached to an upper portion of a front windshield, a rear surface of a room mirror, a front head portion of a vehicle body, or the like. In the case of imaging the rear, the camera 10 is attached to an upper portion of a rear windshield, a back door, or the like. In the case of imaging the side, the camera 10 is attached to a door mirror, or the like. For example, the camera 10 periodically and repeatedly images surroundings of the vehicle M. The camera 10 may be a stereo camera.

The radar device 12 emits radio waves, such as millimeter waves, around the vehicle M and detects radio waves reflected by surrounding objects (reflected waves) to detect at least positions (distances and orientations) of the objects. The radar device 12 is attached to the vehicle M at any location. The radar device 12 may detect a position and a speed of an object using a frequency modulated continuous wave (FM-CW) method.

The LIDAR 14 emits light to the vicinity of the vehicle M and measures scattered light. The LIDAR 14 detects a distance to a target on the basis of the time between light emission and reception. The emitted light is, for example, pulsed laser light. The LIDAR 14 is attached to the vehicle M at any location.

The communication device 20 uses, for example, a network such as a cellular network, a Wi-Fi network, Bluetooth (registered trademark), dedicated short range communication (DSRC), a local area network (LAN), a wide area network (WAN), or the Internet to communicate with, for example, other vehicles present around the vehicle M, a terminal device of a user using the vehicle M, or various server devices.

The HMI 30 outputs various types of information to an occupant (including a driver) of the vehicle M and receives an input operation performed by the occupant. The HMI 30 includes, for example, a display and a speaker. The display is, for example, a liquid crystal display (LCD), an organic electro luminescence (EL) display device, or the like. The display displays various images (including videos) in the embodiment. The display may be with integrated with an input as a touch panel. The speaker outputs a predetermined sound (for example, an alarm, a voice message, or the like). Further, in addition to (or instead of) the display and the speaker, the HMI 30 may be microphones, buzzers, touch panels, switches, keys, or the like. Examples of the switches include switches for executing or terminating predetermined driving control (for example, ACC or LKAS), or the like, which can be executed by a driving controller, which will be described later, and switches for approving (permitting) or rejecting driving control recommendations (suggestions) from the system (vehicle system 1) side. Also, examples of the switches may include switches for performing direction indicating operations (blinker switches), or the like.

The vehicle sensor 40 includes a vehicle speed sensor for detecting a speed of the vehicle M, an acceleration sensor for detecting an acceleration, a yaw rate sensor for detecting a yaw rate (for example, a rotational angular velocity around a vertical axis passing through a center of gravity point of the vehicle M), and a direction sensor for detecting an orientation of the vehicle M. Also, the vehicle sensor 40 may be provided with a position sensor for detecting a position of the vehicle. The position sensor is, for example, a sensor for acquiring position information (longitude and latitude information) from a Global Positioning System (GPS) device. Further, the position sensor may be a sensor for acquiring the position information using a Global Navigation Satellite System (GNSS) receiver 51 of the navigation device 50. The vehicle sensor 40 may derive the speed of the vehicle M from a difference (that is, a distance) in the position information at a predetermined time in the position sensor. The results detected by the vehicle sensor 40 are output to the automated driving control device 100.

The navigation device 50 includes, for example, the GNSS receiver 51, a navigation HMI 52, and a route decider 53. The navigation device 50 stores first map information 54 in a storage device such as a hard disk drive (HDD) or a flash memory. The GNSS receiver 51 identifies a position of the vehicle M on the basis of signals received from a GNSS satellite. The position of the vehicle M may be identified or supplemented by an inertial navigation system (INS) that uses the output of the vehicle sensor 40. The navigation HMI 52 includes a display device, a speaker, a touch panel, keys, or the like. The GNSS receiver 51 may be provided in the vehicle sensor 40. The navigation HMI 52 may be partially or entirely shared with the above-described HMI 30. The route decider 53 decides, for example, a route (hereinafter, a route on a map) from a position of the vehicle M specified by the GNSS receiver 51 (or any input position) to a destination input by the occupant using the navigation HMI 52 with reference to the first map information 54. The first map information 54 is, for example, information in which road shapes are expressed by links indicating roads (an example of a moving path) and nodes connected by the links. The first map information 54 may include point of interest (POI) information, or the like. The route on the map is output to the MPU 60. The navigation device 50 may perform route guidance using the navigation HMI 52 on the basis of the route on the map. The navigation device 50 may transmit the current position and the destination to a navigation server via the communication device 20 and acquire a route equivalent to the route on the map from the navigation server. The navigation device 50 outputs the decided route on the map to the MPU 60.

The MPU 60 includes, for example, a recommended lane decider 61, and stores second map information 62 in a storage device such as an HDD or a flash memory. The recommended lane decider 61 divides the route on the map provided by the navigation device 50 into a number of blocks (for example, every 100 m in a traveling direction of the vehicle), and decides recommended lanes for each block with reference to the second map information 62. The recommended lane decider 61 decides in which lane from the left the vehicle travels. When there is a branch on the route on the map, the recommended lane decider 61 decides a recommended lane so that the vehicle M can travel along a reasonable route to proceed to a branch destination.

The second map information 62 is map information with higher accuracy than the first map information 54. The second map information 62 includes, for example, the number of lanes, types or shapes of road dividing lines (hereinafter referred to as dividing lines), information about centers of lanes, information about road boundaries, or the like. Physical boundaries include, for example, sound barriers, guardrails, fences, curbs, median strips, tunnel side walls, and the like. Also, the second map information 62 may include road shape information, traffic regulation information, address information (addresses and postal codes), facility information, parking lot information, telephone number information, or the like. The road shape information may be, for example, lane widths, gradients, branches, merging points, intersections, curvatures (which may be read as radii of curvature. The same applies below) of roads, amounts of curvature change (amounts of curvature change per predetermined distance), or the like. The second map information 62 may be updated (renewed) at any time by the communication device 20 communicating with an external device. The first map information 54 and the second map information 62 may be provided as an integrated piece of map information. In addition, the map information may be stored in a storage 190.

The driving operator 80 includes, for example, a steering wheel, an accelerator pedal, and a brake pedal. Also, The driving operator 80 may include a shift lever, a special steering wheel, a joystick, or other operators. For example, an operation detector that detects an amount of operation of an operator performed by the occupant or the presence or absence of an operation is attached to each operator of the driving operator 80. The operation detector detects, for example, a steering angle and a steering torque of the steering wheel, an amount of depression of the accelerator pedal or the brake pedal, or the like. In addition, the operation detector outputs detection results to the automated driving control device 100, or one of the driving force output device 200, the brake device 210, and the steering device 220, or both thereof.

The automated driving control device 100 executes various types of driving control relating to automated driving for the vehicle M. The automated driving control device 100 includes, for example, a first controller 120, a second controller 160, an HMI controller 180, and the storage 190. The first controller 120, the second controller 160, and the HMI controller 180 are each realized by, for example, a hardware processor such as a central processing unit (CPU) executing a program (software). Further, some or all of these constituent elements may be realized by hardware (including circuitry) such as a large scale integration (LSI), an application specific integrated circuit (ASIC), a field-programmable gate array (FPGA), a graphics processing unit (GPU), or a system on chip (SOC), or may be realized by software in cooperation with hardware. The above-described program may be stored in advance in a storage device (a storage device including a non-transitory storage medium) such as an HDD, a flash memory, or the like of the automated driving control device 100, or may be stored in a removable storage medium such as a DVD, a CD-ROM, or a memory card and installed in a storage device of the automated driving control device 100 by inserting the storage medium (non-transitory storage medium) into a drive device, a card slot, or the like.

The storage 190 may be realized by the above-described various storage devices, or an electrically erasable programmable read only memory (EEPROM), a read only memory (ROM), or a random access memory (RAM), or the like. The storage 190 stores, for example, various types of information, programs, or the like according to the embodiment. Also, the storage 190 may store the map information (for example, the first map information 54 and the second map information 62).

FIG. 2 is a functional configuration diagram of the first controller 120 and the second controller 160. The first controller 120 includes, for example, a recognizer 130 and an action plan generator 140. The first controller 120 realizes, for example, a function based on artificial intelligence (AI) and a function based on a pre-given model in parallel. For example, the function of “recognizing an intersection” may be realized by executing in parallel recognition of an intersection by deep learning or the like and recognition based on pre-given conditions (signals, road markings, or the like that can be pattern matched), and scoring and evaluating both of them comprehensively. This ensures reliability of the automated driving. In addition, the first controller 120 executes control relating to the automated driving of the vehicle M on the basis of, for example, instructions from the MPU 60, the HMI controller 180, or the like.

The recognizer 130 recognizes surrounding conditions of the vehicle M on the basis of recognition results of the detection device DD (information input from the camera 10, the radar device 12, and the LIDAR 14). For example, the recognizer 130 recognizes a state of the object present around (within a predetermined distance from) the vehicle M, such as a position, a speed, an acceleration, or the like of the object. Examples of the object include, for example, other vehicles, traffic participants such as pedestrians or bicycles, physical boundaries for dividing roads (moving paths), or the like. The position of the object is recognized as a position on absolute coordinates with a representative point (a center of gravity, a center of a drive shaft, or the like) of the vehicle M as the origin, and is used for control. The position of the object may be represented by a representative point such as a center of gravity or a corner of the object, or may be represented by a represented region. If the object is a mobile object such as another vehicle, the “state” of the object may include, for example, an acceleration, a jerk, or a “behavior state” (for example, whether another vehicle is changing lanes or is about to change lanes) of the mobile object.

In addition, the recognizer 130 recognizes, for example, stop lines, obstacles, red lights, toll booths, other road phenomena, markings on roads (speed limits), and road signs indicating speed limits. Also, the recognizer 130 may recognize locations or shapes of road boundaries, buildings around roads, and the like. The recognizer 130 includes, for example, a first recognizer 132, a second recognizer 134, and a third recognizer 136. Details of these functions will be described below.

The action plan generator 140 generates an action plan for driving the vehicle M by automated driving on the basis of the recognition results of the recognizer 130, or the like. For example, the action plan generator 140 generates a target trajectory (target travel path) along which the vehicle M will automatically (without depending on a driver’s operation) travel in the future so that the vehicle M travels in principle along the recommended lanes decided by the recommended lane decider 61 and can cope with the surrounding conditions of the vehicle M on the basis of the recognition results of the recognizer 130, or the like. The target trajectory includes, for example, a speed element. For example, the target trajectory is expressed as a path along which points (path points) to be reached by the vehicle M are arranged in order. The path points are points at which the vehicle M should arrive at each predetermined travel distance (for example, about a few meters) along the road, and separately, target speeds and target accelerations are generated as part of the target trajectory for each predetermined sampling time (for example, about a few decimal second). In addition, the path points may be positions at which the vehicle M should arrive at each predetermined sampling time. In this case, information about the target speeds and the target accelerations is expressed as intervals between the path points.

The action plan generator 140 may set automated driving events when the target trajectory is generated. Examples of the events include, for example, a constant speed traveling event in which the vehicle M is caused to travel in the same lane at a constant speed, a following traveling event corresponding to ACC in which the vehicle M follows another vehicle that is within a predetermined distance (for example, within 100 [m]) in front of the vehicle M and is closest to the vehicle M, a lane keeping traveling event corresponding to the LKAS in which the vehicle M is caused to travel in the center of the travel lane, a lane change event corresponding to ALC in which the vehicle M is caused to change lanes from the vehicle’s own lane to an adjacent lane, a branching event in which the vehicle M is caused to branch into a destination side lane at a road branch point, a joint event in which the vehicle M is caused to join a main lane at a joint point, a takeover event for terminating the automated driving and switching to manual driving, and the like. Examples of the events may include, for example, an overtaking event in which the vehicle M is first caused to change lanes to an adjacent lane, to overtake a forward vehicle along the adjacent lane, and then to change lanes back to the original lane, an avoidance event in which the vehicle M is caused to perform at least one of braking and steering to avoid an obstacle present in front of the vehicle M, and the like.

For example, the action plan generator 140 may change an event already decided for a current section to another event or set a new event for the current section in accordance with the surrounding conditions of the vehicle M recognized during traveling of the vehicle M. The action plan generator 140 may change an event already set for the current section to another event or set a new event for the current section in accordance with an operation of the occupant performed on the HMI 30. The action plan generator 140 generates the target trajectory in accordance with to the set event. The action plan generator 140 includes, for example, a comparer 142 and a traveling controller 144. Details of these functions will be described below.

The second controller 160 controls the driving force output device 200, the brake device 210, and the steering device 220 so that the vehicle M passes through the target trajectory generated by the action plan generator 140 at the scheduled time. The traveling controller 144 and the second controller 160 are examples of a “driving controller.”

The second controller 160 includes, for example, a target trajectory acquirer 162, a speed controller 164, and a steering controller 166. The target trajectory acquirer 162 acquires information about the target trajectory (path points) generated by the action plan generator 140 and stores it in a memory (not shown). The speed controller 164 controls the driving force output device 200 or the brake device 210 on the basis of speed elements associated with the target trajectory stored in the memory. The steering controller 166 controls the steering device 220 in accordance with a curved state of the target trajectory stored in the memory. The processing of the speed controller 164 and the steering controller 166 is realized, for example, by a combination of feedforward control and feedback control. As an example, the steering controller 166 executes a combination of feedforward control in accordance with a curvature of the road ahead of the vehicle M and feedback control based on discrepancy from the target trajectory.

Referring back to FIG. 1, the HMI controller 180 notifies the occupant of the vehicle M of predetermined information via the HMI 30. The predetermined information includes, for example, information relating to traveling of the vehicle M, such as information about a state of the vehicle M and information about driving control. The information about the state of the vehicle M includes, for example, a speed, an engine speed, a shift position, or the like of the vehicle M. Also, the information about the driving control includes, for example, information for executing inquiry of the presence or absence of execution of driving control by automated driving and of whether or not automated driving is to be started, information about a driving control state by automated driving, information about driving modes, information for prompting the occupant to drive when driving is switched from automated driving to manual driving, or the like. In addition, the predetermined information may include information about the surrounding conditions recognized by the detection device DD. Further, the predetermined information may include information unrelating to traveling of the vehicle M, such as television programs, content (for example, movies) stored in a storage medium such as a DVD. Also, the predetermined information may include, for example, information about a current position or a destination in automated driving, and a remaining amount of fuel in the vehicle M. The HMI controller 180 may output the information received by the HMI 30 to the communication device 20, the navigation device 50, the first controller 120, or the like.

The HMI controller 180 may cause the HMI 30 to output inquiry information for the occupant, processing results by the first controller 120 and the second controller 160, or the like. The HMI controller 180 may transmit various types of information output by the HMI 30 to a terminal device used by the user of the vehicle M via the communication device 20.

The driving force output device 200 outputs a driving force (torque) for traveling the vehicle to driving wheels. The driving force output device 200 includes, for example, a combination of an internal combustion engine, an electric motor, a transmission, and the like, and an electronic control unit (ECU) that controls these. The ECU controls the above configuration in accordance with information input from the second controller 160 or information input from the accelerator pedal of the driving operator 80.

The brake device 210 includes, for example, a brake caliper, a cylinder that transmits a hydraulic pressure to the brake caliper, an electric motor that generates the hydraulic pressure in the cylinder, and a brake ECU. The brake ECU controls the electric motor in accordance with information input from the second controller 160 or information input from the brake pedal of the driving operator 80, so that a brake torque in accordance with a braking operation is output to each wheel. The brake device 210 may be provided with, as a backup, a mechanism that transmits a hydraulic pressure generated by operating the brake pedal to the cylinder via a master cylinder. Also, the brake device 210 is not limited to the configuration described above, and may be an electronically controlled hydraulic brake device that controls an actuator in accordance with the information input from the second controller 160 to transmit the hydraulic pressure of the master cylinder to the cylinder.

The steering device 220 includes, for example, a steering ECU and an electric motor. For example, the electric motor applies a force to a rack and pinion mechanism to change a direction of a steering wheel. The steering ECU drives the electric motor to change the direction of the steering wheel in accordance with the information input from the second controller 160 or information input from the steering wheel of the driving operator 80.

### Recognizer, Comparer, and Driving Controller

Next, details of driving control of the vehicle M based on the functions of the recognizer 130 (mainly the first recognizer 132, the second recognizer 134, and the third recognizer 136), the comparer 142, and the driving controller (mainly the traveling controller 144) will be described.

FIG. 3 is a diagram showing an example of a traveling condition of the vehicle M according to the embodiment. In the example of FIG. 3, dividing lines CL1 and CL2 recognized by the camera 10, and dividing lines ML1 to ML2 obtained from the map information on the basis of the position information of the vehicle M are shown. Using the map information shown in FIG. 3, a lane L1 on which the vehicle M travels is defined by the dividing lines ML1 to ML2. In the example of FIG. 3, the dividing lines CL1 and CL2 are examples of a “first dividing line,” and the dividing lines ML1 to ML2 are examples of a “second dividing line.” Also, in the following, the dividing lines CL1 and CL2 may be referred to as “device dividing lines CL1 and CL2,” and the dividing lines ML1 to ML2 may be referred to as “map dividing lines ML1 to ML2.” In addition, when the device dividing lines CL1 and CL2 are not distinguished from each other, they may be referred to simply as “device dividing lines CL,” and when the map dividing lines ML1 to ML2 are not distinguished from each other, they may be referred to simply as “map dividing lines ML.”

Also, in the example of FIG. 3, it is assumed that a first object OB1 is present on a left outer side (left far side) of the lane L1, and a second object OB2 is present on a right outer side (right far side) of the lane L1 when viewed from the vehicle M. The first object OB1 and the second object OB2 may be physical boundaries such as guardrails, fences, soundproof walls, or the like, or may be buildings present around the lane L1. In addition, in the example of FIG. 3, the vehicle M is traveling at a speed VM in an extension direction of the lane L1. Further, although FIG. 3 shows a curved road with a predetermined curvature as an example, the scope of application of the present embodiment is not limited to curved roads, and may include other road shapes.

Also, in the example of FIG. 3, LKAS control may be being executed for the vehicle M. During LKAS execution, the driving control is executed to control at least one of steering and a speed of the vehicle M so that a target trajectory K1 is generated to prevent the vehicle M from deviating from the lane L1 (in other words, to cause the vehicle M to travel along a center of the lane L1), and cause the vehicle M to travel along the generated target trajectory K1. In this driving control, feedforward control and feedback control are performed any time on the basis of the target trajectory and a position of the vehicle M to adjust a steering angle, a speed, or the like of the vehicle M.

### First Recognizer 132

The first recognizer 132 uses images captured by the camera 10 to recognize the device dividing lines (first dividing lines) CL defining lanes present in the vicinity including the traveling direction of the vehicle M. For example, the first recognizer 132 performs known analysis processing (for example, edge extraction, feature extraction such as color, shape, and size, pattern matching processing, character recognition processing, or the like) on an image captured by the camera 10 (hereinafter referred to as a camera image), and recognizes, from the image analysis results, the device dividing lines CL along which the vehicle M travels. In the case of recognizing the device dividing lines CL, the first recognizer 132 extracts edge points having a large difference in brightness from adjacent pixels in the camera image and connects the edge points, thereby recognizing the device dividing lines CL on an image plane thereof. Also, the first recognizer 132 converts positions of the device dividing lines CL relative to a position of a representative point of the vehicle M into a vehicle coordinate system (for example, as shown in FIG. 3, an XY plane coordinates in which a front direction of the vehicle M is defined as an X axis and a vehicle width direction (lateral direction) thereof is defined as a Y axis).

In the example of FIG. 3, the first recognizer 132 recognizes the device dividing lines CL1 and CL2 on the basis of the camera image. Also, the example of FIG. 3 shows the device dividing lines CL1 and CL2 present within a predetermined distance ahead of the vehicle M (in the traveling direction), but the device dividing lines on the sides and rear of the vehicle M may also be recognized. In addition, the first recognizer 132 may recognize a curvature of the lane L1 on the basis of the camera image, or may recognize amounts of curvature change of the device dividing lines CL1 and CL2. The amounts of curvature change are, for example, change rates over time in the curvatures of the device dividing lines CL1 and CL2 recognized by the camera 10 x [m] ahead as viewed from the vehicle M.

Also, the first recognizer 132 may recognize objects (camera objects) present in the vicinity (within a predetermined distance) of the vehicle M by performing the above-described analysis processing or the like on the camera image. In the example of FIG. 3, the first object OB1 and the second object OB2 are recognized by the first recognizer 132.

In addition, the first recognizer 132 may experience a decrease in recognition accuracy of the device dividing lines CL depending on various traveling conditions, such as the influence of road gradient (a gradient in a width direction of the lane L1 (lateral gradient) and a gradient in the extension direction of the lane L1 (longitudinal gradient)), the influence of a condition in which the dividing lines are spaced apart from the vehicle M, or external disturbances such as weather or a direction of sunlight, the influence of generation of blind spots due to curves or traffic congestion, and the like.

### Second Recognizer 134

The second recognizer 134 recognizes the map dividing lines ML defining the travel lane of the vehicle M from the map information on the basis of the position information of the vehicle M. For example, on the basis of the position information of the vehicle M acquired by the vehicle sensor 40 or the GNSS receiver 51, the second recognizer 134 refers to the map information (the first map information 54 and the second map information 62), and recognizes the map dividing lines ML defining the lane L1 present around the vehicle M including the traveling direction from the map information.

In the example of FIG. 3, the second recognizer 134 recognizes the map dividing lines ML1 and ML2 on the basis of the map information. Also, the second recognizer 134 may recognize curvatures or gradients of the lanes L1 and L2 from the map information, or may recognize amounts of curvature change of the map dividing lines ML1 and ML2.

### Third Recognizer 136

The third recognizer 136 recognizes objects (for example, fences, guardrails, soundproof walls, walls of surrounding buildings, and the like) around the vehicle M on the basis of an output of the second detection device detecting the surrounding conditions of the vehicle M. For example, the third recognizer 136 recognizes the objects (radar objects) in the vicinity including the traveling direction of the vehicle M on the basis of the detection results obtained by the radar device 12, which is an example of the second detection device. For example, the third recognizer 136 extracts an object group present within a short distance (within a predetermined distance) from the detection results (radar object group) obtained by the radar device 12 by clustering, and recognizes positions (shapes) of the objects (radar objects) in front of or on the sides of the vehicle M on the basis of the extraction results. Also, the third recognizer 136 may recognize distances between the vehicle M and the objects, directions in which the objects are present when viewed from the vehicle M, or the like. In addition, the third recognizer 136 may recognize objects in the lane L1 (for example, another vehicle, a median strip, and the like) by distinguishing them from objects outside the lane L1, or may recognize objects that remain stationary (stationary objects) by distinguishing them from objects that are moving (moving objects) on the basis of amounts of change in position over a predetermined period of time or other factors. For example, the objects used in second comparison processing, which will be described later, are stationary objects present outside the lane L1.

Also, instead of (or in addition to) the radar device 12, the third recognizer 136 may recognize positions, distances, directions, or the like of the objects in front of or on the sides of the vehicle M on the basis of the detection results obtained by the LIDAR 14, which is an example of the second detection device. In addition, the third recognizer 136 may correct the information (positions or the like) of the objects detected by the radar device 12 or the LIDAR 14 on the basis of the information of the objects (camera objects) recognized by the first recognizer 132. In the example of FIG. 3, the third recognizer 136 recognizes the first object OB1 and the second object OB2 present around the vehicle M.

### Comparer 142

The comparer 142 performs first comparison processing based on the device dividing lines CL and the map dividing lines ML recognized by the recognizer 130. Also, when predetermined conditions are met, the comparer 142 performs second comparison processing based on the objects recognized by the third recognizer 136, and at least one of the device dividing lines CL and the map dividing lines ML. The first comparison processing and the second comparison processing will be described in detail below.

### First Comparison Processing

As the first comparison processing, the comparer 142 compares the device dividing lines CL1 and CL2 recognized by the first recognizer 132 with the map dividing lines ML1 and ML2 recognized by the second recognizer 134 to determine whether they match (or are discrepant from each other). For example, the comparer 142 compares the device dividing line CL1 present closest to the right of the vehicle M with the map dividing line ML1 to derive their degree of discrepancy (an index value indicating how discrepant they are), and compares the device dividing line CL2 present closest to the left of the vehicle M with the map dividing line ML2 to derive their degree of discrepancy. Also, the comparer 142 may determine that the device dividing lines CL and the map dividing lines ML match (are not discrepant) if the degree of discrepancy derived from the comparison is less than a threshold value, and determine that they do not match (are discrepant from each other) if the degree of discrepancy is at least the threshold value.

Here, a comparative example of the dividing lines will be described in detail. For example, the comparer 142 superimposes the device dividing lines CL1 and CL2, as well as the map dividing lines ML1 and ML2, on the plane (XY plane) of the vehicle coordinate system with the position of the representative point of vehicle M as a reference. Then, the comparer 142 compares the dividing lines serving as comparison targets with each other (the device dividing line CL1 and the map dividing line ML1, and the device dividing line CL2 and the map dividing line ML2). Also, for example, the comparison is performed over a range (section) from the position of the vehicle M (the point P1 shown in FIG. 3) to a position a predetermined distance away therefrom in the traveling direction (the point P2 shown in FIG. 3) as a comparison target range. The predetermined distance may be a variable distance set on the basis of the recognition performance (recognition limit) of the first recognizer 132, or may be a fixed distance.

The degree of discrepancy in the comparison between the device dividing lines CL and the map dividing lines ML is, for example, a degree of an amount of deviation in a lane width direction (road width direction) (width direction variation). In this case, the comparer 142 increases the degree of discrepancy as the amount of deviation increases. The comparer 142 may perform matching determination using an amount of deviation W1 between lateral positions of the dividing lines CL1 and ML1 and an amount of deviation W2 between lateral positions of the dividing lines CL2 and ML2, or may perform matching determination using an average value, maximum value, or minimum value of the amounts of deviation W1 and W2 within the comparison target section.

Also, for example, instead of (or in addition to) the amount of deviation between the lateral positions described above, the degree of discrepancy may be a degree of magnitude of an angle formed by the two dividing lines (the device dividing lines CL and the map dividing lines ML) serving as the comparison targets (degree of discrepancy corresponding to a deviation angle). In this case, the comparer 142 increases the degree of discrepancy as the deviation angle increases. For example, the comparer 142 may perform matching determination using the deviation angle formed by the dividing lines CL1 and ML1 and the deviation angle formed by the dividing lines CL2 and ML2, or may perform the matching determination using an average value, maximum value, or minimum value of the deviation angles of them.

Also, the degree of discrepancy may be a degree (magnitude) of a difference between amounts of curvature change of the dividing lines, instead of (or in addition to) the degree of discrepancy in accordance with the degree of amount of deviation between the lateral positions or the deviation angle formed by the dividing lines described above. The amount of curvature change is mainly used when the lane is a curved road as shown in FIG. 3. In this case, the comparer 142 increases the degree of discrepancy as the degree of the difference in the amount of curvature change increases. The comparer 142 may perform matching determination using the difference in the amount of curvature change between the dividing lines CL1 and ML1 and the difference in the amount of curvature change between the dividing lines CL2 and ML2 in the comparison target range, or may perform the matching determination using an average value, maximum value, or minimum value of the differences between them.

### Second Comparison Processing

For example, as a predetermined condition, when the first comparison processing determines that the degree of discrepancy between the device dividing line CL and the map dividing line ML is at least the threshold value (or when it is determined that the dividing lines do not match each other because the degree of discrepancy is at least the threshold value), the comparer 142 performs the second comparison processing.

As the second comparison processing, for example, the comparer 142 performs processing that includes comparing the positions (shapes) of the objects (the first object OB1 and the second object OB2) recognized by the third recognizer 136 with the device dividing lines CL, and the positions (shapes) of the objects with the map dividing lines ML. In this case, in the comparison target range, the comparer 142 derives the degrees of discrepancy between the dividing lines and the objects on the basis of degrees of parallelism between shapes of the dividing lines serving as the comparison targets among the device dividing lines CL and the map dividing lines ML, and positions (shapes) of one or more objects recognized by the third recognizer 136. In this case, the comparer 142 increases the degree of discrepancy as the degree of parallelism is smaller (or decreases the degree of discrepancy as the degree of parallelism is greater). Further, the comparer 142 may determine that the dividing lines serving as the comparison targets and the objects match each other (are not discrepant from each other) if the degree of discrepancy derived from the comparison is less than the threshold value, and determine that they do not match each other (are discrepant from each other) if the degree of discrepancy is at least the threshold value.

Also, in the example of FIG. 3, within the comparison target range from the point P1 to the point P2, the second object OB2 is present in the lateral direction (in the lane width direction) of the lane L1 in a section from the point P1 to a point Pa (hereinafter referred to as a first section), and the first object OB1 and the second object OB2 are present in the lateral direction of the lane L2 in a section from the point Pa to the point P2 (hereinafter referred to as a second section). Accordingly, the comparer 142 derives the degree of parallelism on the basis of the second object OB2, the device dividing lines CL, and the map dividing lines ML in the first section, and derives the degree of parallelism on the basis of the first object OB1 and the second object OB2, the device dividing lines CL, and the map dividing lines ML in the second section. In addition, the comparer 142 may derive the degrees of parallelism in the entire comparison target range on the basis of the results of the degree of parallelism in each of the first and second sections.

Also, if there are a plurality of objects, as in the second section, the comparer 142 may derive the degree of parallelism for each object and use the average value, maximum value, or minimum value thereof to derive the degree of discrepancy, or may select any of the plurality of objects and derive the degree of parallelism for the selected object.

Here, in the case of selecting any object, for example, the comparer 142 selects the object with the closest distance to the dividing line serving as the comparison target, among the plurality of objects. Objects close to the dividing line serving as the comparison target (for example, fences, guardrails, or the like) are likely to have shapes that aligns with the extension direction of the dividing line, and thus by selecting the object closest to the dividing line, more appropriate comparison processing can be performed. Also, the comparer 142 may select the object with the largest (longest) shape (length) among the plurality of objects. Thus, a more accurate degree of parallelism between the object and the dividing line can be derived. In addition, the comparer 142 may select the object closest to the traveling direction of the vehicle M among the plurality of objects. Thus, the degree of parallelism with respect to the dividing line in the traveling direction with the greatest necessity can be derived, and more appropriate comparison processing (matching determination), or the like can be performed on the basis of the results thereof.

FIG. 4 is a diagram for describing a method for deriving the degree of parallelism. FIG. 4 shows an example of deriving the degree of parallelism between the first object OB1 and the device dividing line CL1 and the degree of parallelism between the first object OB1 and the map dividing line ML1 in the second section, but the a similar method may also be applied to another combination of the second object OB2, the device dividing line CL2, the map dividing line ML2, and the like.

In the second section, the comparer 142 acquires, for example, lateral distance Dc-1, Dc-2, ..., and Dc-n of the lane L1 between the first object OB1 and the device dividing line CL1 at predetermined intervals in the extension direction. Then, the comparer 142 derives the degree of parallelism on the basis of the difference between the maximum and minimum values of the obtained plurality of distances Dc-1, Dc-2, ..., and Dc-n. In this case, the comparer 142 increases the degree of parallelism as the difference decreases. Also, instead of (or in addition to) the difference between the maximum and minimum values, the comparer 142 may acquire information about stability of the distance Dc (smallness of the number of times the distance Dc increases or decreases and the amount of increase or decrease) in the second section, and derive the degree of parallelism in accordance with the acquired stability. In this case, the comparer 142 increases the degree of parallelism as the stability increases. In addition, the comparer 142 acquires lateral distances Dm-1, Dm-2, ..., and Dm-n of the lane L1 between the first object OB1 and the map dividing line ML1, and similarly derives the degree of parallelism on the basis of the difference between the maximum and minimum values, the stability, or the like.

Also, the degree of parallelism may be the average value, maximum value, or minimum value of the degrees of parallelism based on the left and right device dividing lines CL1 and CL2, or may be the average value, maximum value, or minimum value of the degrees of parallelism based on the left and right map dividing lines ML1 and ML2. In addition, instead of (or in addition to) the method of deriving the degree of parallelism from the deviations between the objects and the dividing lines described above, the comparer 142 may calculate the degree of parallelism from angles (discrepant angles) formed by the respective extension directions of the objects and the dividing lines. In this case, the comparer 142 increases the degree of parallelism as the angle decreases. Also, the method of deriving the degree of parallelism in the embodiment is not limited to the above example, and other methods may be used.

Also, in the second comparison processing, in the case of deriving the degree of parallelism described above, for example, the comparer 142 may prioritize one of the device dividing lines CL and the map dividing lines ML to derive the degree of parallelism between the prioritized dividing lines and the objects. Which of the device dividing lines CL and the map dividing lines ML is to be prioritized may be determined in advance, or may be selected through a predetermined determination. For example, the comparer 142 prioritizes the map dividing lines ML when the traveling condition is such that the recognition accuracy of the device dividing lines CL by the first recognizer 132 as described above decreases, and the comparer 142 prioritizes the device dividing lines CL when the traveling condition is not such that the recognition accuracy decreases. Specifically, the map dividing lines ML are prioritized when a gradient of the lane L1 obtained from the map information is at least a predetermined value, when a curvature of the road is at least a predetermined value, or when the weather is bad. In this way, by selecting the dividing lines to be prioritized for comparison with the objects depending on the traveling conditions of the vehicle M, more appropriate recognition processing can be performed. In addition, the processing load can be reduced as compared to the case of performing the comparison processing using both the device dividing lines CL and the map dividing lines ML.

Also, if the object is not recognized by the third recognizer 136, the comparer 142 either does not perform the second comparison processing, or, even if it does perform the second comparison processing, processes it as if the degree of discrepancy between the object and the dividing line serving as the comparison target is at least the threshold value.

The traveling controller 144 performs control (driving control) of the vehicle M on the basis of the recognition results of the recognizer 130, the comparison results of the comparer 142, and the like. For example, the traveling controller 144 decides the driving control for the vehicle M on the basis of the above recognition results, the comparison results, and the like, and generates the target trajectory based on the decided driving control. “Deciding driving control” may include, for example, deciding the content (type) of driving control or deciding whether or not to execute (curb) driving control. Also, “executing driving control” may include, for example, switching the content of driving control and executing it, as well as continuing driving control that is already being executed. “Curbing driving control” may include not only not executing driving control, but also lowering a driving control mode (automation level).

Here, the driving control includes a first driving mode and a second driving mode in which a degree of driving assistance is lower than in the first driving mode or tasks on the occupant of the vehicle M are greater than in the first driving mode. A lower degree of driving assistance indicates, for example, a lower degree of automation in driving control. A lower degree of automation indicates, for example, that the automated driving control device 100 has a lower degree of control over the steering or speed of the vehicle M (a degree of necessity of the driver’s intervening in the steering, acceleration, or deceleration operation is high). A greater task on an occupant includes, for example, a large number of tasks or a heavy task imposed on the occupant. Examples of the task include, for example, monitoring surroundings of the vehicle M and the occupant’s operation of the driving operator 80. The operation of the driving operator 80 includes, for example, a state in which the driver grips the steering wheel (hereinafter, a hands-on state). Also, the driving control may include a third driving mode and the like in which the degree of driving assistance is lower than in the second driving mode or the tasks on the occupant of the vehicle M are greater than in the second driving mode. Further, the driving mode with the lowest degree of driving assistance or the greatest task on the occupant of the vehicle M may be a full manual driving mode (a mode in which no driving control is executed).

For example, the first driving mode allows driving control (for example, ACC, LKAS, ALC, TJP, CMBS, and the like) with no (or the lightest) task on the occupant in a state in which the occupant of the vehicle M is not gripping the steering wheel (hereafter, hands-off state). Also, in the second driving mode, the tasks imposed on the occupant may include, for example, monitoring the surroundings of the vehicle M and keeping the hands-on state.

For example, the traveling controller 144 determines whether or not a situation of the vehicle M satisfies hands-off conditions when there is an occupant’s instruction via the HMI 30, or when it is determined that the surrounding conditions recognized by the first recognizer 132 satisfies conditions for starting driving control and the predetermined driving control such as LKAS control or ACC control is started. The hands-off conditions are conditions for executing the driving control in the hands-off state (first driving mode), and include, for example, in the case of LKAS, recognition of the left and right dividing lines, a time to contact TTC with a nearby obstacle (another vehicle or the like) being equal to or greater than a predetermined time, or the like, but are not limited thereto. Also, the time to contact TTC is derived, for example, by dividing a relative distance by a relative speed in a relationship between the vehicle M and the other vehicle. If the hands-off conditions are met, the traveling controller 144 performs control for executing the first driving mode (in other words, switches from the second driving mode to the first driving mode).

Also, the traveling controller 144 continues the first driving mode if the first driving mode (for example, driving control in the hands-off state) is being executed and the degree of discrepancy between the device dividing line CL and the map dividing line ML is less than the threshold value in the first comparison processing of the comparer 142. For example, if LKAS control for traveling in the center of the travel lane L1 is being executed as the first driving mode, the traveling controller 144 causes the second controller 160 to execute control so that the target trajectory for traveling in the center of the travel lane L1 is generated on the basis of the device dividing lines CL1 and CL2 or the map dividing lines ML1 and ML2, and traveling is performed along the generated target trajectory K1.

Also, if the second driving mode is being executed and the degrees of discrepancy of the dividing lines in the comparison target range are less than the threshold value, the traveling controller 144 may perform control to switch from the second driving mode to the first driving mode. In this case, in the case of performing switching control, the traveling controller 144 may cause the HMI 30 to output information informing the occupant that switching is possible or inquiring whether or not to switch (or information suggesting switching), and may perform switching of the driving mode if information indicating permission to switch is received from the occupant. Further, after an instruction to switch to the first driving mode is received from the HMI 30, the traveling controller 144 may switch from the second driving mode to the first driving mode at a timing when the degrees of discrepancy of the left and right dividing lines become less than the threshold value.

Also, if the degrees of discrepancy between the device dividing lines CL and the map dividing lines ML are less than the threshold value, the traveling controller 144 may correct the positions of the map dividing lines ML in a stage before the target trajectory K1 for the vehicle M is generated. In this case, the traveling controller 144 may correct the positions of the map dividing lines ML to match the positions of the device dividing lines CL in the road sections within the comparison target range. Correction of position may be, for example, correction of the amount of deviation in the lateral direction (lane width direction) of the dividing lines, correction of the deviation angle, or correction of the curvature or amount of curvature change. Correcting to match indicates correcting so that the positions of the dividing lines are aligned with (overlap) each other and correcting so that the degrees of discrepancy are within the allowable range smaller than the threshold value. For example, the traveling controller 144 can generate a more appropriate target trajectory K1 using the corrected map dividing lines ML1 and ML2, and more appropriate driving control can be realized using this target trajectory K1.

Also, the traveling controller 144 may continue the first driving mode if the first driving mode is being executed and if the first comparison processing shows that the degrees of discrepancy between the device dividing lines CL and the map dividing lines ML are at least the threshold value and the second comparison processing shows that at least one of the degree of discrepancy between the object and the device dividing lines CL and the degree of discrepancy between the object and the map dividing lines ML is less than the threshold value. Thus, the continuity of the first driving mode can be improved, and more appropriate driving control can be executed depending on the surrounding conditions.

Further, if the degree of discrepancy from the position of the object based on the second comparison processing is less than the threshold value, the traveling controller 144 performs steering control of the vehicle M in at least the first driving mode on the basis of the dividing line having the smaller degree of discrepancy between the device dividing lines CL and the map dividing lines ML. The dividing line with the smaller degree of discrepancy from the object is more likely to be the actual dividing line, and thus by using that dividing line, the driving control of the first driving mode can be more appropriately executed.

Also, if the first driving mode is being executed, and the first comparison processing shows that the degrees of discrepancy between the device dividing lines CL and the map dividing lines ML are at least the threshold value and the second comparison processing shows that one of the device dividing lines CL and the map dividing lines ML is prioritized, the traveling controller 144 continues the first driving mode when the degree of discrepancy between one prioritized dividing line and the object is less than the threshold value. This processing can improve the continuity of the first driving mode, and can execute more appropriate driving control depending on the surrounding conditions. In addition, since the processing load can be reduced as compared to the case of performing comparison with the object at each of the device dividing lines CL and map dividing lines ML, more flexible driving control can be executed.

Further, if the degree of discrepancy between the one prioritized dividing line and the position of the object is less than the threshold value on the basis of the results of the second comparison processing, the traveling controller 144 performs steering control of the vehicle M in at least the first driving mode on the basis of the one prioritized dividing line. By performing the driving control on the basis of the prioritized dividing line serving as the comparison target, more appropriate driving control can be executed.

Also, in the dividing line recognition of the embodiment, the object information recognized by the third recognizer 136 is used only as third-party reference or insurance information. This is because, depending on the surrounding conditions of the vehicle M, there may be no objects in the vicinity, objects may not be recognized even if they exist, or the objects that can be recognized may not be shaped along the lane. On the other hand, there is a desire to improve the continuity of the first driving mode (driving in the hands-off state). For that reason, in the embodiment, even if the degree of discrepancy between the device dividing lines CL and the map dividing lines ML is at least the threshold value, the object around the vehicle can be recognized, and if the object is along the travel lane (the degree of parallelism is large and the degree of discrepancy is small), the first driving mode is made to be continuable, and thus more appropriate driving control can be executed depending on the surrounding conditions.

Also, if the degree of discrepancy between the object and the dividing line serving as the comparison target is at least the threshold value in the second comparison processing, the traveling controller 144 executes the driving control to switch from the first driving mode to the second driving mode. Thus, more appropriate driving control can be executed for the vehicle M, thereby further improving safety.

### Modified Examples

Also, if the degree of discrepancy of only one of the left and right sides is at least the threshold value and the degree of discrepancy of the other is less than the threshold value, the traveling controller 144 may set the dividing line on the other side to a position offset by the same distance toward the other side and continue the first driving mode, on the basis of the distance between the other dividing line and the vehicle M in the lateral direction (lane width direction). Thus, the hands-off state can be continued, thereby further improving the continuity of driving control. In addition, in the embodiment, control relating to the continuity of the driving control described above may be performed not only in the above-described LKAS control but also in other driving control (for example, ACC control, and the like).

### Process Flow

A process executed by the automated driving control device 100 of the embodiment will be described below. The following description will be made, primarily focusing on a driving control process based on the recognition results or the like of the dividing lines among the processes executed by the automated driving control device 100. The process shown below may be repeatedly executed at predetermined timing or at predetermined intervals.

FIG. 5 is a flowchart showing an example of a flow of the driving control process in the embodiment. In the example of FIG. 5, the first recognizer 132 recognizes the surrounding conditions, including the dividing lines (device dividing lines CL) present around the vehicle M on the basis of the output of the first detection device (step S100). Next, the second recognizer 134 refers to the map information on the basis of the position information of the vehicle M and recognizes the dividing lines (map dividing lines ML) present around the vehicle M from the map information (step S110). Next, the third recognizer 136 recognizes the objects present around the vehicle M on the basis of the output of the second detection device (step S120). The order of the processes of steps S100 to S120 may be different.

Next, the traveling controller 144 determines whether or not to start predetermined driving control (step S130). The predetermined driving control is driving control in which the steering, speed, and the like of the vehicle M are controlled on the basis of the recognized dividing lines, and includes, for example, LKAS control, ACC control, or the like. The predetermined driving control may be started, for example, when an instruction to execute the predetermined driving control is received via an operation of the HMI 30 executed by the occupant of the vehicle M, or when the surrounding conditions recognized by the first recognizer 132 satisfy conditions for starting the predetermined driving control.

If it is determined that the predetermined driving control is to be started, the traveling controller 144 determines whether or not the hands-off conditions are satisfied (step S140). If the hands-off conditions are determined to be satisfied, the traveling controller 144 executes the first driving mode in which the hands-off state is possible (step S150). In the process of step S140, for example, if LKAS control is executed as the first driving mode, the traveling controller 144 generates a target trajectory for the vehicle M to pass through the center of the travel lane L1 defined by the recognized left and right device dividing lines CL or map dividing lines ML, and causes the second controller 160 to execute steering control and speed control of the vehicle M to travel along the generated target trajectory. Next, the comparer 142 performs the first comparison processing (step S160). Details of the first comparison processing will be described later.

Next, the traveling controller 144 determines whether or not the degree of discrepancy between the device dividing lines CL and the map dividing lines ML is less than the threshold value on the basis of the results of the first comparison processing (step S170). If it is determined that the degree of discrepancy is less than the threshold value, the traveling controller 144 corrects the positions of the device dividing lines CL and the map dividing lines ML (step S180), and continues the first driving mode (hands-off state) (step S190). In addition, if it is determined in the process of step S170 that the degree of discrepancy is not less than the threshold value, the comparer 142 performs the second comparison processing (step S200). Details of the second comparison processing will be described later.

Next, the traveling controller 144 determines whether or not the degree of discrepancy between the object and the dividing lines is less than the threshold value on the basis of the results of the second comparison processing (step S210). If it is determined that the degree of discrepancy is less than the threshold value, the traveling controller 144 selects one of the device dividing lines CL and the map dividing lines ML (step S220), and continues the first driving mode (hands-off state) (step S190). Also, if it is determined in the process of step S210 that the degree of discrepancy is not less than the threshold value, the control to switch from the first driving mode to the second driving mode in the hands-on state is performed (step S230). Thus, the process of the present flowchart ends.

Also, if it is determined in the process of step S130 that the predetermined driving control is not started, or it is determined in the process of step S140 that the hands-off conditions are not satisfied, the process of the present flowchart ends.

### Step S160: First Comparison Processing

FIG. 6 is a flowchart showing an example of the first comparison processing. The example of FIG. 6 is a specific example of the process of step S160 described above. In the example of FIG. 6, the comparer 142 compares the device dividing lines CL1 and CL2 defining the travel lane of the vehicle M with the map dividing lines ML1 and ML2 (step S161), and derives the degree of discrepancy between the device dividing lines CL and the map dividing lines ML, for example, on the basis of the amount of deviation between the device dividing lines CL and the map dividing lines ML, the deviation angle, the difference in the amount of curvature change of the dividing lines (step S162). Thus, the process of the present flowchart ends.

### Step S200: Second Comparison Processing (First Example)

FIG. 7 is a flowchart showing an example of a first example of the second comparison processing. The example of FIG. 7 is a specific example of the process of step S200 described above. In the example of FIG. 7, the comparer 142 derives the degree of parallelism between the device dividing lines CL and the object recognized by the third recognizer 136 (step S201A). Next, the comparer 142 derives the degree of parallelism between the map dividing lines ML and the object recognized by the third recognizer 136 (step S201A). The order of the processes of steps S201A and S202A may be reversed. Next, the comparer 142 derives the degree of discrepancy from the object individually on the basis of the respective degrees of parallelism derived by the processes of steps S201A and S202A (step S203A). Thus, the process of the flowchart ends. Also, in the case of performing the processing according to the first example, in the process of step S210 described above, it is determined whether either the degree of discrepancy based on the degree of parallelism between the device dividing lines CL and the object, or the degree of discrepancy based on the degree of parallelism between the map dividing lines ML and the object, is less than the threshold value. In addition, in the case of performing the processing according to the first example, in the process of step S220 described above, the dividing lines with the smaller degree of discrepancy from the object are selected among the device dividing lines CL and the map dividing lines ML.

### Step S200: Second Comparison Processing (Second Example)

FIG. 8 is a flowchart showing a second example of the second comparison processing. The example of FIG. 8 is a specific example of the process of step S200 described above. In the example of FIG. 8, the comparer 142 selects one of the device dividing lines CL and the map dividing lines ML that is prioritized by a predetermined determination (condition) or the like (step S201B), and derives the degree of parallelism between the object recognized by the third recognizer 136 and the prioritized dividing line (step S202B). Next, the comparer 142 derives the degree of discrepancy from the object on the basis of the derived degree of parallelism (step S203B). Thus, the process of the flowchart ends. Also, in the case of performing the processing according to the second example, in the process of step S210 described above, it is determined whether or not the degree of discrepancy based on the degree of parallelism between the one prioritized dividing line and the object is less than the threshold value. In addition, in the case of performing the processing according to the second example, in the process of step S220 described above, the one prioritized dividing line is selected in the process of step 201B among the device dividing lines CL and the map dividing lines ML.

Also, in the embodiment, the processes of steps S160 to S230 shown in FIG. 5 may be performed before the process of step S150 as conditions for executing the first driving mode. In this case, the process of step S150 is executed instead of the process of step S190, and the second driving mode is continued in the process of step S230.

As described above, according to the embodiment described above, the automated driving control device 100 (an example of the vehicle control device) includes the first recognizer 132 that recognizes the dividing lines defining the travel lane of the vehicle M as the first dividing line (device dividing lines CL) on the basis of the output of the first detection device detecting the dividing lines around the vehicle M, the second recognizer 134 that recognizes the dividing lines defining the travel lane of the vehicle M from the map information as the second dividing line (map dividing lines ML) on the basis of the position information of the vehicle M, the third recognizer 136 that recognizes the object around the vehicle M on the basis of the output of the second detection device detecting the surrounding conditions of the vehicle M, the comparer 142 that performs the first comparison processing based on the first dividing lines and the second dividing lines, and the driving controller (the traveling controller 144 and the second controller 160) performs the driving control of the vehicle M on the basis of the results of the first comparison processing. The comparer 142 performs the second comparison processing including the comparison of the object recognized by the third recognizer 136 with the first dividing line and the comparison of the object with the second dividing line if a degree of discrepancy between the first dividing line and the second dividing line is at least the threshold value in the first comparison processing. The driving control includes at least the first driving mode and the second driving mode in which the degree of driving assistance is lower than in the first driving mode or the tasks on the occupant of the vehicle M are greater than in the first driving mode. The driving controller continues the first driving mode if the first driving mode is being executed and at least one of the degree of discrepancy between the object and the first dividing line and the degree of discrepancy between the object and the second dividing line based on the results of the second comparison processing is less than the threshold value, and thus the recognition accuracy of the dividing lines can be improved, thereby executing more appropriate driving control. In addition, this can ultimately contribute to the development of sustainable transportation systems.

Also, according to the embodiment described above, the automated driving control device (an example of the vehicle control device) 100 includes the first recognizer 132, the second recognizer 134, the third recognizer 136, the comparer 142, and the driving controller (the traveling controller 144 and the second controller 160) described above. The comparer 142 performs the second comparison processing on the basis of the one prioritized dividing line and the object recognized by the third recognizer 136 if the degree of discrepancy between the first dividing line and the second dividing line is at least the threshold value in the first comparison processing and one of the first dividing line and the second dividing line is prioritized. The driving control includes at least the first driving mode and the second driving mode in which the degree of driving assistance is lower than in the first driving mode or the tasks on the occupant of the vehicle is greater than in the first driving mode. The traveling controller continues the first driving mode if the first driving mode is being executed and the degree of discrepancy between the one prioritized dividing line and the object on the basis of the results of the second comparison processing is less than the threshold value, and thus the recognition accuracy of the dividing lines can be improved, thereby executing more appropriate driving control. In addition, this can ultimately contribute to the development of sustainable transportation systems.

Further, according to the embodiment, even if the device dividing lines CL and the map dividing lines ML are discrepant from each other, by evaluating the dividing lines on the basis of the surrounding object detected by the radar device or the like, more appropriate recognition of the dividing lines can be performed, thereby further improving the continuity of driving control.

The embodiment described above can be expressed as below.

A vehicle control device includes a storage medium configured to store computer-readable instructions, and

a processor connected to the storage medium,

the processor executing the computer-readable instructions to:

recognize dividing lines defining a travel lane of a vehicle as a first dividing line on the basis of an output of a first detection device detecting dividing lines around the vehicle;

recognize dividing lines defining the travel lane of the vehicle from map information as a second dividing line on the basis of position information of the vehicle;

recognize an object around the vehicle on the basis of an output of a second detection device detecting surrounding conditions of the vehicle;

perform first comparison processing based on the first dividing line and the second dividing line;

perform driving control of the vehicle on the basis of the results of the first comparison processing; and

perform second comparison processing including comparison of the object with the first dividing line and comparison of the object with the second dividing line if a degree of discrepancy between the first dividing line and the second dividing line is at least a threshold value in the first comparison processing,

wherein the driving control includes at least a first driving mode and a second driving mode in which a degree of driving assistance is lower than in the first driving mode or tasks on the occupant of the vehicle are greater than in the first driving mode, and

the first driving mode is continued if the first driving mode is being executed and at least one of the degree of discrepancy between the object and the first dividing line and the degree of discrepancy between the object and the second dividing line based on the results of the second comparison processing is less than the threshold value.

Also, the embodiment described above can also be expressed as below.

A vehicle control device includes a storage medium configured to store computer-readable instructions, and

a processor connected to the storage medium,

the processor executing the computer-readable instructions to:

recognize dividing lines defining a travel lane of a vehicle as a first dividing line on the basis of an output of a first detection device detecting dividing lines around the vehicle;

recognize dividing lines defining the travel lane of the vehicle from map information as a second dividing line on the basis of position information of the vehicle;

recognize an object around the vehicle on the basis of an output of a second detection device detecting surrounding conditions of the vehicle;

perform first comparison processing based on the first dividing line and the second dividing line;

perform driving control of the vehicle on the basis of the results of the first comparison processing; and

perform second comparison processing on the basis of one prioritized dividing line and the object if a degree of discrepancy between the first dividing line and the second dividing line is at least a threshold value in the first comparison processing, and one of the first dividing line and the second dividing line is prioritized,

wherein the driving control includes at least a first driving mode and a second driving mode in which a degree of driving assistance is lower than in the first driving mode or tasks on the occupant of the vehicle are greater than in the first driving mode, and

the first driving mode is continued if the first driving mode is being executed and the degree of discrepancy between the one prioritized dividing line and the object is less than the threshold value on the basis of the results of the second comparison processing.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
a memory storing a instructions; and
a processor configured to execute the instructions stored in the memory to:
recognize dividing lines defining a travel lane of a vehicle as a first dividing line on the basis of an output of a first detection device detecting dividing lines around the vehicle;
recognize dividing lines defining the travel lane of the vehicle from map information as a second dividing line on the basis of position information of the vehicle;
recognize an object around the vehicle on the basis of an output of a second detection device detecting surrounding conditions of the vehicle;
perform first comparison processing based on the first dividing line and the second dividing line; and
perform driving control of the vehicle on the basis of the results of the first comparison processing,
wherein the processor performs second comparison processing including at least one of comparison of the object recognized with the first dividing line and comparison of the object with the second dividing line if a degree of discrepancy between the first dividing line and the second dividing line is at least a threshold value in the first comparison processing,
the driving control includes at least a first driving mode and a second driving mode in which a degree of driving assistance is lower than in the first driving mode or tasks on the occupant of the vehicle are greater than in the first driving mode, and
the processor continues the first driving mode if the first driving mode is being executed and at least one of the degree of discrepancy between the object and the first dividing line and the degree of discrepancy between the object and the second dividing line based on the results of the second comparison processing is less than the threshold value.

2. The vehicle control device according to claim 1,
wherein the processor performs comparison one prioritized dividing line between the first dividing line and the second dividing line and the object, as the second comparison processing, and
the processor continues the first driving mode if the first driving mode is being executed and the degree of discrepancy between the one prioritized dividing line and the object is less than the threshold value on the basis of the results of the second comparison processing.

3. The vehicle control device according to claim 1,
wherein the processor performs comparison the object and the first dividing line and comparison the object and the second dividing line as the second comparison processing, and
the processor continues the first driving mode if the first driving mode is being executed and at least one of the degree of discrepancy between the object and the first dividing line and the degree of discrepancy between the object and the second dividing line based on the results of the second comparison processing is less than the threshold value.

4. The vehicle control device according to claim 1,
wherein the processor switches from the first driving mode to the second driving mode if the first driving mode is being executed and the degree of discrepancy from the object based on the second comparison processing is at least the threshold value.

5. The vehicle control device according to claim 1, wherein the processor performs at least steering control of the vehicle on the basis of the dividing line having the smaller degree of discrepancy between the first dividing line and the second dividing line if the degree of discrepancy from a position of the object based on the second comparison processing is less than the threshold value.

6. The vehicle control device according to claim 2, wherein the processor performs at least steering control of the vehicle on the basis of one prioritized dividing line if the degree of discrepancy between a position of the object and the one prioritized dividing line based on the second comparison processing is less than the threshold value.

7. The vehicle control device according to claim 1, wherein the processor derives the degree of discrepancy between the dividing line serving as a comparison target and the object on the basis of a degree of parallelism between the dividing line serving as the comparison target among the first and second dividing lines and one or more of the objects recognized in the second comparison processing.

8. A vehicle control method configured to cause a computer to execute:
recognizing dividing lines defining a travel lane of a vehicle as a first dividing line on the basis of an output of a first detection device detecting dividing lines around the vehicle;
recognizing dividing lines defining the travel lane of the vehicle from map information as a second dividing line on the basis of position information of the vehicle;
recognizing an object around the vehicle on the basis of an output of a second detection device detecting surrounding conditions of the vehicle;
performing first comparison processing based on the first dividing line and the second dividing line;
performing driving control of the vehicle on the basis of the results of the first comparison processing; and
performing second comparison processing including at least one of comparison of the object with the first dividing line and comparison of the object with the second dividing line if a degree of discrepancy between the first dividing line and the second dividing line is at least a threshold value in the first comparison processing,
wherein the driving control includes at least a first driving mode and a second driving mode in which a degree of driving assistance is lower than in the first driving mode or tasks on the occupant of the vehicle are greater than in the first driving mode, and
the first driving mode is continued if the first driving mode is being executed and at least one of the degree of discrepancy between the object and the first dividing line and the degree of discrepancy between the object and the second dividing line based on the results of the second comparison processing is less than the threshold value.

9. A computer-readable non-transitory storage medium storing a program configured to cause a computer to execute:
recognizing dividing lines defining a travel lane of a vehicle as a first dividing line on the basis of an output of a first detection device detecting dividing lines around the vehicle;
recognizing dividing lines defining the travel lane of the vehicle from map information as a second dividing line on the basis of position information of the vehicle;
recognizing an object around the vehicle on the basis of an output of a second detection device detecting surrounding conditions of the vehicle;
performing first comparison processing based on the first dividing line and the second dividing line;
performing driving control of the vehicle on the basis of the results of the first comparison processing; and
performing second comparison processing including at least one of comparison of the object with the first dividing line and comparison of the object with the second dividing line if a degree of discrepancy between the first dividing line and the second dividing line is at least a threshold value in the first comparison processing,
wherein the driving control includes at least a first driving mode and a second driving mode in which a degree of driving assistance is lower than in the first driving mode or tasks on the occupant of the vehicle are greater than in the first driving mode, and
the first driving mode is continued if the first driving mode is being executed and at least one of the degree of discrepancy between the object and the first dividing line and the degree of discrepancy between the object and the second dividing line based on the results of the second comparison processing is less than the threshold value.
